(19) United States
(12) Patent Application Publication
(10) Pub. No.: US 2026/0187176 A1
(43) Pub. Date: Jul. 2, 2026

(54) HINT-BASED LATENCY REDUCTION IN CONTENT DISPLAY

(71) Applicant: Meta Platforms Technologies, LLC, Menlo Park, CA (US)

(72) Inventors: Arshad Sultan, Jersey City, NJ (US); Anton Pavlovich Gladkov, Brooklyn, NY (US); Kyongtai Alex Min, Hoboken, NJ (US)

(21) Appl. No.: 19/005,991

(22) Filed: Dec. 30, 2024

(51) Int. Cl. G06F 16/955; G06F 40/205

(52) U.S. Cl. CPC G06F 16/955; G06F 40/205

(57) ABSTRACT

An embodiment includes receiving, from a first server, a first hint comprising a Uniform Resource Locator (URL) corresponding to a first content. An embodiment includes parsing the first hint, the parsing comprising extracting the URL from the first hint. An embodiment includes downloading, from a second server hosting the first content at the URL, the first content. An embodiment includes receiving, from the first server subsequent to receiving the first hint, first metadata corresponding to the first content. An embodiment includes displaying, using the first metadata, the first content.

### TECHNICAL FIELD

The present disclosure generally relates to client-server computing, and more particularly to hint-based latency reduction in content display.

### BACKGROUND

Content, or media, refers to text, still images, audio, or video (often including audio), and the like. In a presently available content viewing implementation, a user uses a software application executing on a client device or client system to request content to view. In a media request, the software application requests the content and related data from a server. The server responds with a package that includes metadata such as an advertisement to be displayed along with the requested content, comments from other users, recommendations of other content the user might be interested in, and content-related statistics such as the number of likes or reposts the content has received, as well as the requested content or a location (e.g., a Uniform Resource Locator (URL)) of the requested content. For improved performance, in one typical configuration one server maintains content-related metadata, while another server (e.g., part of a content delivery network (CDN)) stores the content itself. Using a CDN allows for optimizing performance by storing content at a server that is the fewest hops or the lowest number of network seconds away from the requesting client, or that has the highest current or historical availability, or by storing multiple copies of popular content near (in network terms) requesting systems. Using a CDN also allows for optimizing for cost by storing content at a server that is the least expensive. The requesting client receives and parses the package, extracting any content URLs, uses the extracted URLs to download the actual content, and displays the content along with data extracted from the metadata.

However, because much of the metadata (e.g., advertisements and recommendations) is user-specific, the server generates the metadata package upon receiving a request from a client. Generating, assembling, and sending the metadata package can take some time, and the client must wait for the complete package to arrive to extract a content URL, begin downloading the actual content, and display the downloaded content along with data extracted from the metadata. For example, in one presently available configuration average latency is approximately 800 milliseconds. Thus, there is a need to improve a user's content viewing experience by shortening elapsed time from a media request until the user views the requested content.

### SUMMARY

Some embodiments of the present disclosure provide a computer-implemented method for hint-based latency reduction in content display. The method includes receiving, from a first server, a first hint comprising a Uniform Resource Locator (URL) corresponding to a first content; parsing the first hint, the parsing comprising extracting the URL from the first hint; downloading, from a second server hosting the first content at the URL, the first content; receiving, from the first server subsequent to receiving the first hint, first metadata corresponding to the first content; and displaying, using the first metadata, the first content.

Some embodiments of the present disclosure provide a non-transitory computer-readable medium storing a program for hint-based latency reduction in content display. The program, when executed by a computer, configures the computer to receive, from a first server, a first hint comprising a Uniform Resource Locator (URL) corresponding to a first content; parse the first hint, the parsing comprising extracting the URL from the first hint; download, from a second server hosting the first content at the URL, the first content; receive, from the first server subsequent to receiving the first hint, first metadata corresponding to the first content; and display, using the first metadata, the first content.

Some embodiments of the present disclosure provide a system for hint-based latency reduction in content display. The system comprises a processor and a non-transitory computer readable medium storing a set of instructions, which when executed by the processor, configure the processor to receive, from a first server, a first hint comprising a Uniform Resource Locator (URL) corresponding to a first content; parse the first hint, the parsing comprising extracting the URL from the first hint; download, from a second server hosting the first content at the URL, the first content; receive, from the first server subsequent to receiving the first hint, first metadata corresponding to the first content; and display, using the first metadata, the first content.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement hint-based latency reduction in content display, according to some embodiments.

FIG. 2 is a block diagram illustrating details of a system for hint-based latency reduction in content display, according to some embodiments.

FIG. 3 depicts a block diagram of an example configuration for hint-based latency reduction in content display, in accordance with an illustrative embodiment.

FIG. 4 depicts a flow diagram of hint-based latency reduction in content display, in accordance with an illustrative embodiment.

FIG. 5 depicts an example hint used in hint-based latency reduction in content display, in accordance with an illustrative embodiment.

FIG. 6 depicts another example hint used in hint-based latency reduction in content display, in accordance with an illustrative embodiment.

FIG. 7 depicts another example hint used in hint-based latency reduction in content display, in accordance with an illustrative embodiment.

FIG. 8 depicts example hints used in hint-based latency reduction in content display, in accordance with an illustrative embodiment.

FIG. 9 depicts another example hint used in hint-based latency reduction in content display, in accordance with an illustrative embodiment.

FIG. 10 depicts a flowchart of an example process for hint-based latency reduction in content display. in accordance with an illustrative embodiment.

FIG. 11 depicts another flowchart of an example process for hint-based latency reduction in content display. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing hint-based latency reduction in content display. In particular, an embodiment receives, from a first server, a first hint comprising a URL corresponding to a first content; parses the first hint, the parsing comprising extracting the URL from the first hint; downloads, from a second server hosting the first content at the URL, the first content; receives, from the first server subsequent to receiving the first hint, first metadata corresponding to the first content; and displays, using the first metadata, the first content.

An embodiment executing on a client device (client embodiment) generates a media request to a server. A media request is a request for a content intended for display to a user.

An embodiment executing on a server device (server embodiment) receives the media request, and in response generates a hint and sends the hint to a client embodiment. Another server embodiment generates and sends a hint that is unrelated to a media request. A hint is a data package including content related metadata, to be used to reduce latency in content display. Thus, while a hint generated in response to a media request generally includes metadata related to the media requested in the media request, a hint that is not generated in response to a media request is simply a request that a client embodiment perform an action, such as updating a local cache of content or content-related metadata.

Some embodiments use a hint schema to structure information about content or media to be displayed. In one example hint schema, media are arranged in their relative order of display, to indicate to a receiving client which media to prioritize (because they are most likely to be seen by a user) and how that media is to be displayed. However, for a carousel (a wrapper object that includes many media within itself), in the example hint schema the hint includes a hint for only the one item that the user will see first. A resource portion of the example hint schema includes data such as the type (e.g., an image or video), dimensions, URL, identifier and one or more video attributes of a particular content. A content's URL indicates where the content is actually stored (e.g., on a CDN), i.e., where a client embodiment can access the content for download. A content's identifier is a unique label for the content, for use in, e.g., determining whether a content is already cached locally and need not be re-downloaded from another location. A data portion of the example hint schema includes metadata about a content, such as comments, likes, tags, and the like. A latency portion of the example hint schema includes information a client embodiment can use to predict the latency of access to a content. A media content portion of the example hint schema includes data of the content itself, rather than the content's URL, so that the content can be shown to a user right away instead of needing to be fetched from another location such as a node in a CDN. In addition, in some cases it is faster to serve a content that is cached on the server, or to generate a content from data stored on the server, than to reference content that is already on a CDN. Other portions of the example hint schema can be defined to support other server-client communication needs. Other hint schemas, including the same or different information, are also possible and contemplated within the scope of the illustrative embodiments.

A client embodiment receives a hint from a server embodiment, parses the hint, and takes an action based on a result of the parsing. Parsing the hint includes extracting data from the hint. Thus, if the hint includes a URL corresponding to a content, a client embodiment extracts the URL from the hint and begins downloading the referenced content from a server hosting the content at the URL. In embodiments, the content referenced by the URL is hosted on the same server as the hint sender, on a node of a CDN, or on a different server.

If the hint includes a latency prediction associated with downloading a content, a client embodiment extracts the latency prediction from the hint and uses the latency prediction to adjust an appearance of the content referenced in the hint. For example, if the predicted latency is higher than a predefined threshold, a client embodiment might display a smaller version of the content (e.g., a thumbnail), a lower-resolution version of the content, a portion of the content (e.g., one image within a requested carousel of images), a cached advertisement, metadata relating to the content, or otherwise endeavor to keep a user occupied until content is available for display.

If the hint includes a content (e.g., image data), a client embodiment extracts the content from the hint. If the hint includes an identifier of a content, a client embodiment extracts the identifier from the hint. Some client embodiments cache content locally. Thus, one client embodiment determines whether or not content identified by an identifier is present in a local cache, and if not downloads the content from another system (e.g., a server or CDN node).

Subsequent to receiving the hint, a client embodiment receives metadata corresponding to the content that was the subject of the hint from a server embodiment. Some non-limiting examples of metadata corresponding to content are an advertisement to be displayed along with the content, comments from other users relating to the content, recommendations of other content a user might be interested in, and content-related statistics such as the number of likes or reposts a content has received. Because a client embodiment received the hint prior to the metadata, a client embodiment can begin downloading content or otherwise preparing content for display while waiting for the metadata, thus reducing latency.

Using the first metadata, a client embodiment displays the content that was the subject of the hint from a server embodiment. For example, if the metadata included statistics such as the number of likes or reposts a content has received, or other users'comments, a client embodiment displays those statistics or a portion of the comments along with the content itself. As another example, if the metadata included a recommendation for additional comment, a client embodiment displays the recommendation along with the content and offers a user the opportunity to select the recommended comment for viewing As another example, if the metadata included an advertisement, a client embodiment displays the advertisement alongside, before, or during display of the content.

Data sent from the server embodiment can be portioned into one or more hints or portions of metadata. For example, if multiple images are to be displayed, a first hint might include metadata of the first image or two, and a next hint might include metadata of another image or two, for example to accommodate users who scroll quickly through the multiple images. As another example, in some cases content metadata might be ready before advertisements, so a server embodiment might include the content metadata in one hint and the advertisement metadata in a later hint.

A server embodiment uses the data in one or more received media requests to adjust content generation or storage. For example, a server embodiment might use knowledge of which clients have requested particular content to adjust which CDN nodes host that content, or use knowledge of the content being recommended to watch next to generate that content before it is actually requested or cache that content at a CDN closer to the potential requestor, thus improving overall content display latency.

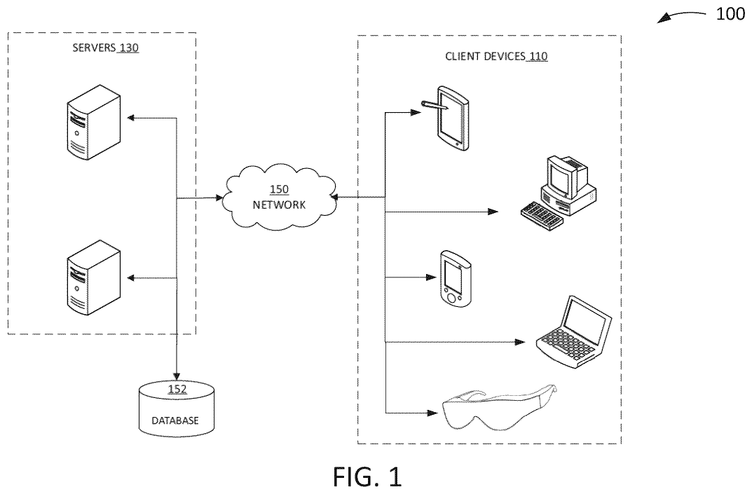

FIG. 1 illustrates a network architecture 100 used to implement hint-based latency reduction in content display, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

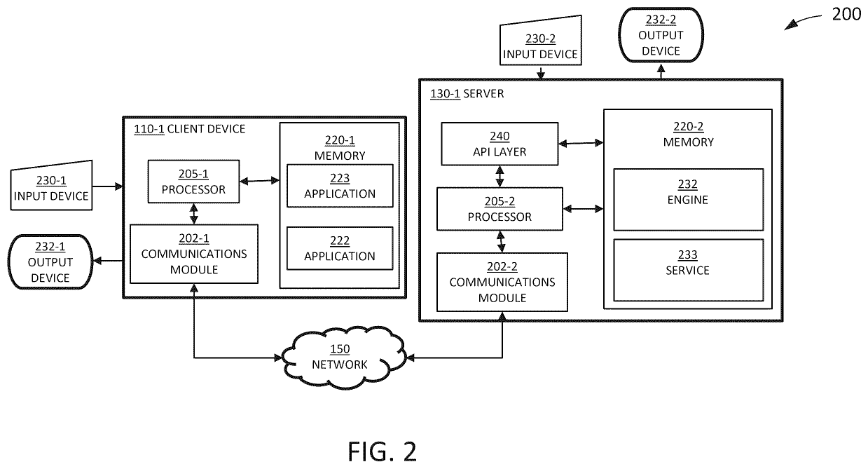

FIG. 2 is a block diagram illustrating details of a system 200 for hint-based latency reduction in content display, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement hint-based latency reduction in content display. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide hint-based latency reduction in content display. The application 223 may communicate with service 233 through API layer 240, for example.

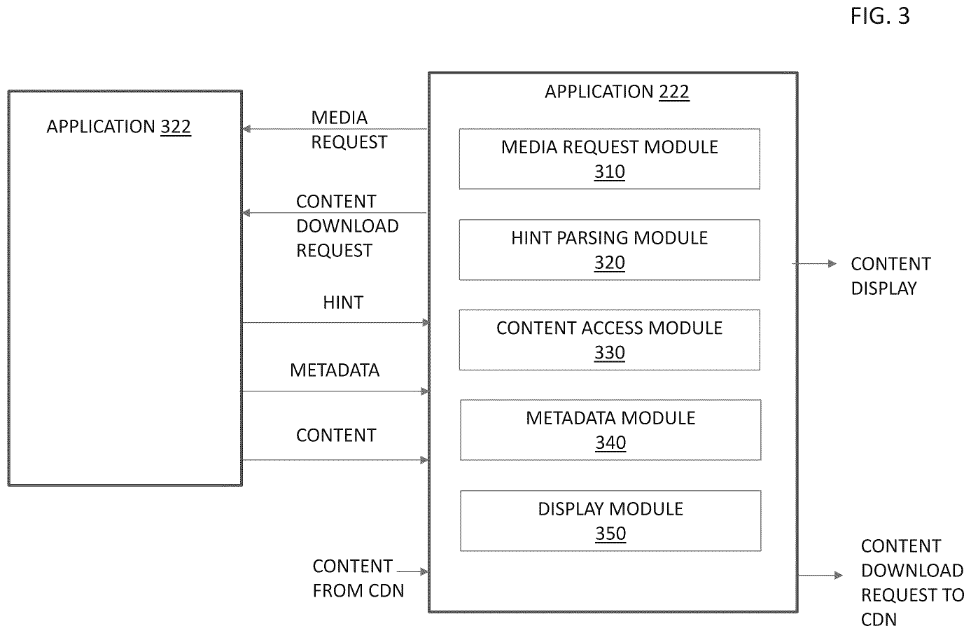

FIG. 3 depicts a block diagram of an example configuration for hint-based latency reduction in content display, in accordance with an illustrative embodiment. Application 222 is the same as application 222 in FIG. 2.

Media request module 310, executing on a client device, generates a media request to a server. A media request is a request for a content intended for display to a user.

Application 322, executing on server 130-1 in FIG. 2, receives the media request, and in response generates a hint and sends the hint to a client embodiment. Another implementation of application 322 generates and sends a hint that is unrelated to a media request. A hint is a data package including content related metadata, to be used to reduce latency in content display. Thus, while a hint generated in response to a media request generally includes metadata related to the media requested in the media request, a hint that is not generated in response to a media request is simply a request that application 222 perform an action, such as updating a local cache of content or content-related metadata.

Some implementations of applications 222 and 322 use a hint schema to structure information about content or media to be displayed. In one example hint schema, media are arranged in their relative order of display, to indicate to a receiving client which media to prioritize (because they are most likely to be seen by a user) and how that media is to be displayed. However, for a carousel (a wrapper object that includes many media within itself), in the example hint schema the hint includes a hint for only the one item that the user will see first. A resource portion of the example hint schema includes data such as the type (e.g., an image or video), dimensions, URL, identifier and one or more video attributes of a particular content. A content's URL indicates where the content is actually stored (e.g., on a CDN), i.e., where application 222 can access the content for download. A content's identifier is a unique label for the content, for use in, e.g., determining whether a content is already cached locally and need not be re-downloaded from another location. A data portion of the example hint schema includes metadata about a content, such as comments, likes, tags, and the like. A latency portion of the example hint schema includes information a client embodiment can use to predict the latency of access to a content. A media content portion of the example hint schema includes data of the content itself, rather than the content's URL, so that the content can be shown to a user right away instead of needing to be fetched from another location such as a node in a CDN. In addition, in some cases it is faster to serve a content that is cached on the server, or to generate a content from data stored on the server, than to reference content that is already on a CDN. Other portions of the example hint schema can be defined to support other server-client communication needs. Other hint schemas, including the same or different information, are also possible.

Hint parsing module 320 receives a hint from application 322, parses the hint, and takes an action based on a result of the parsing. Parsing the hint includes extracting data from the hint. Thus, if the hint includes a URL corresponding to a content, module 320 extracts the URL from the hint and content access module 330 begins downloading the referenced content from a server hosting the content at the URL. For example, the content referenced by the URL is hosted on the same server as application 322, on a node of a CDN, or on a different server.

If the hint includes a latency prediction associated with downloading a content, module 320 extracts the latency prediction from the hint and display module 350 uses the latency prediction to adjust an appearance of the content referenced in the hint. For example, if the predicted latency is higher than a predefined threshold, display module 350 might display a smaller version of the content (e.g., a thumbnail), a lower-resolution version of the content, a portion of the content (e.g., one image within a requested carousel of images), a cached advertisement, metadata relating to the content, or otherwise endeavor to keep a user occupied until content is available for display.

If the hint includes a content (e.g., image data), module 320 extracts the content from the hint. If the hint includes an identifier of a content, module 320 extracts the identifier from the hint. Some implementations of application 222 cache content locally. Thus, one implementation of application 222 determines whether or not content identified by an identifier is present in a local cache, and if not content access module 330 downloads the content from another system (e.g., a server or CDN node).

Subsequent to receiving the hint, metadata module 340 receives metadata corresponding to the content that was the subject of the hint from application 322. Some non-limiting examples of metadata corresponding to content are an advertisement to be displayed along with the content, comments from other users relating to the content, recommendations of other content a user might be interested in, and content-related statistics such as the number of likes or reposts a content has received. Because application 222 received the hint prior to the metadata, application 222 can begin downloading content or otherwise preparing content for display while waiting for the metadata, thus reducing latency.

Using the first metadata, display module 350 displays the content that was the subject of the hint from a server embodiment. For example, if the metadata included statistics such as the number of likes or reposts a content has received, or other users'comments, module 350 displays those statistics or a portion of the comments along with the content itself. As another example, if the metadata included a recommendation for additional comment, module 350 displays the recommendation along with the content and offers a user the opportunity to select the recommended comment for viewing As another example, if the metadata included an advertisement, module 350 displays the advertisement alongside, before, or during display of the content.

Data sent from application 322 can be portioned into one or more hints or portions of metadata. For example, if multiple images are to be displayed, a first hint might include metadata of the first image or two, and a next hint might include metadata of another image or two, for example to accommodate users who scroll quickly through the multiple images. As another example, in some cases content metadata might be ready before advertisements, so application 322 might include the content metadata in one hint and the advertisement metadata in a later hint.

Application 322 uses the data in one or more received media requests to adjust content generation or storage. For example, application 322 might use knowledge of which clients have requested particular content to adjust which CDN nodes host that content, or use knowledge of the content being recommended to watch next to generate that content before it is actually requested or cache that content at a CDN closer to the potential requestor, thus improving overall content display latency.

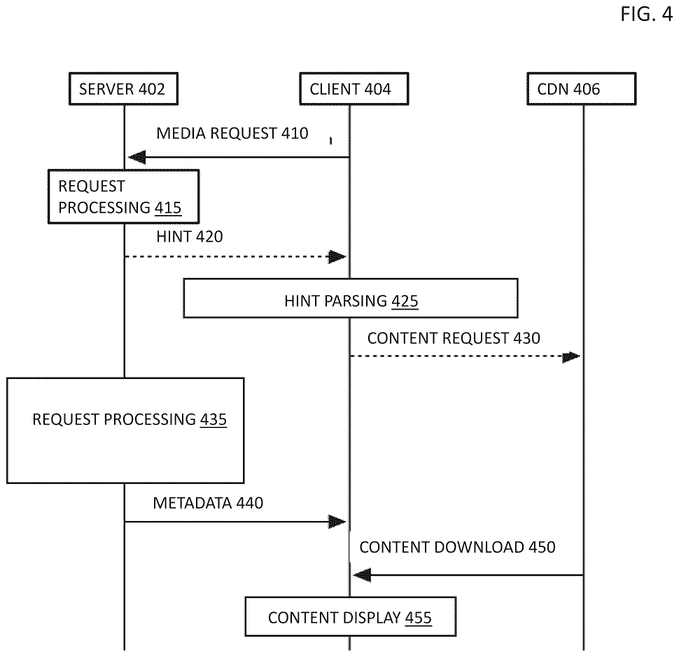

FIG. 4 depicts a flow diagram of hint-based latency reduction in content display, in accordance with an illustrative embodiment. The flow diagram can be executed using applications 222 and 322 in FIG. 3.

Server 402 is an example of server 130-1 in FIG. 2. Client 404 is an example of client device 110-1 in FIG. 2. CDN 406 hosts content for display at client 404. Time progresses from top to bottom in the flow diagram. Thus, client 404 sends media request 410 to server 402. Server 402, in request processing 415, processes the request, generates hint 420, and sends hint 420 to client 404. Client 404, in hint parsing 425, parses hint 420 and because hint 420 includes a content URL for content hosted on CDN 406, generates and sends content request 430 to CDN 406, which responds with content download 450. In the meantime, server 402, in request processing 435, generates and sends metadata 440 to client 404. Once client 404 has metadata 440 and at least a portion of content download 450, in content display 455 client 404 displays the content and metadata to a user.

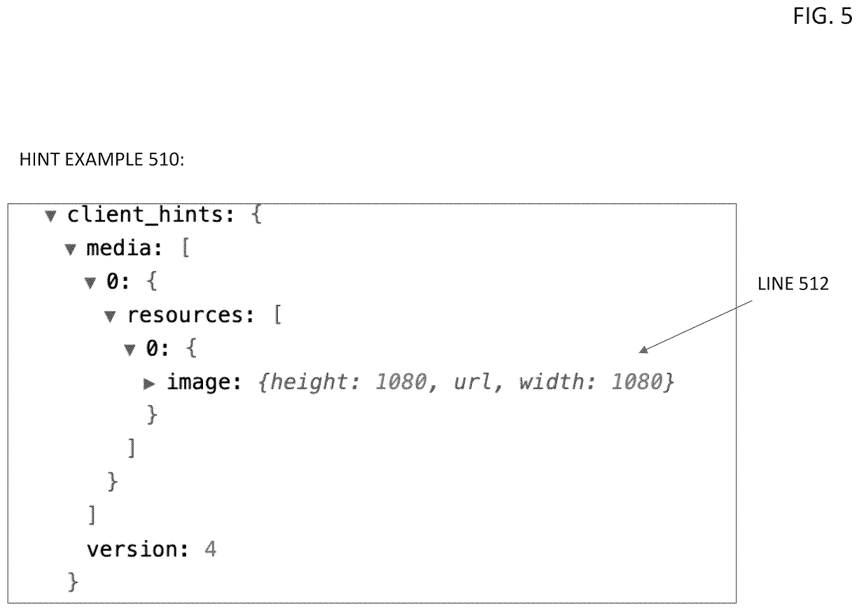

FIG. 5 depicts an example hint used in hint-based latency reduction in content display, in accordance with an illustrative embodiment. The example hint can be parsed by application 222 in FIG. 3. In particular, hint example 510 includes line 512 specifying height, width, and a URL for a single image.

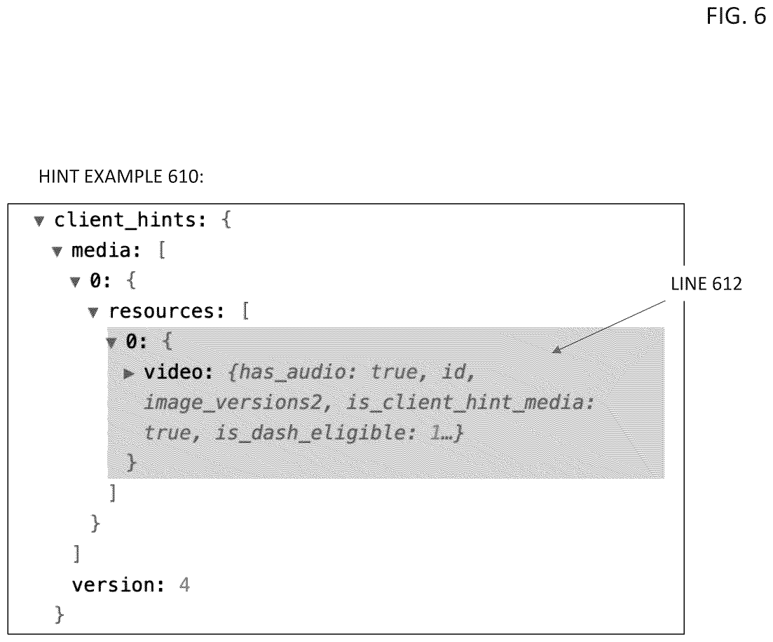

FIG. 6 depicts another example hint used in hint-based latency reduction in content display, in accordance with an illustrative embodiment. The example hint can be parsed by application 222 in FIG. 3. In particular, hint example 610 includes line 612 specifying an identifier and other data for a single video.

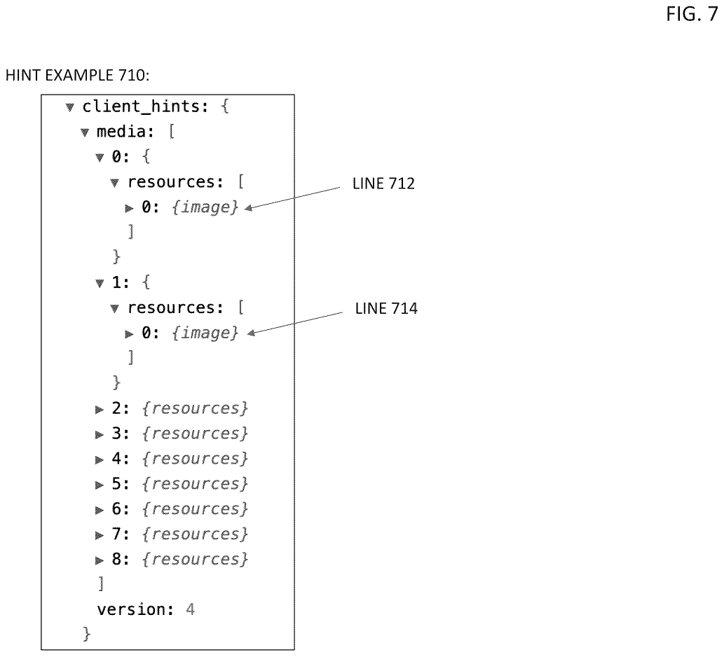

FIG. 7 depicts another example hint used in hint-based latency reduction in content display, in accordance with an illustrative embodiment. The example hint can be parsed by application 222 in FIG. 3. In particular, hint example 710 includes line 712 specifying data for one image, line 714 specifying data for a second image, and additional resource objects (depicted in collapsed form) specifying data for other images. The resource objects are numbered according to the order in which they are to be displayed to a user.

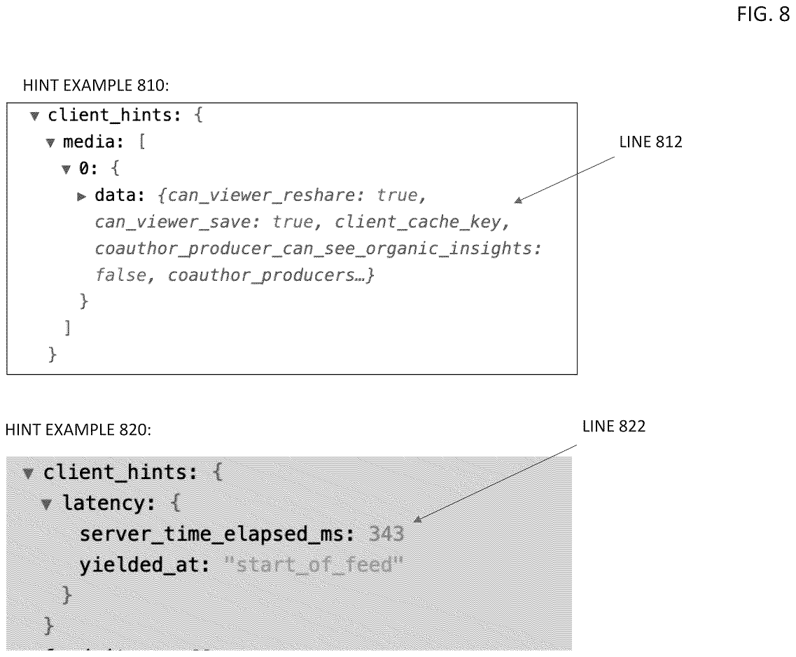

FIG. 8 depicts example hints used in hint-based latency reduction in content display, in accordance with an illustrative embodiment. The example hints can be parsed by application 222 in FIG. 3. In particular, hint example 810 includes line 812 specifying metadata about a content, such as comments, likes, tags, and the like, and hint example 820 includes line 822 specifying latency data.

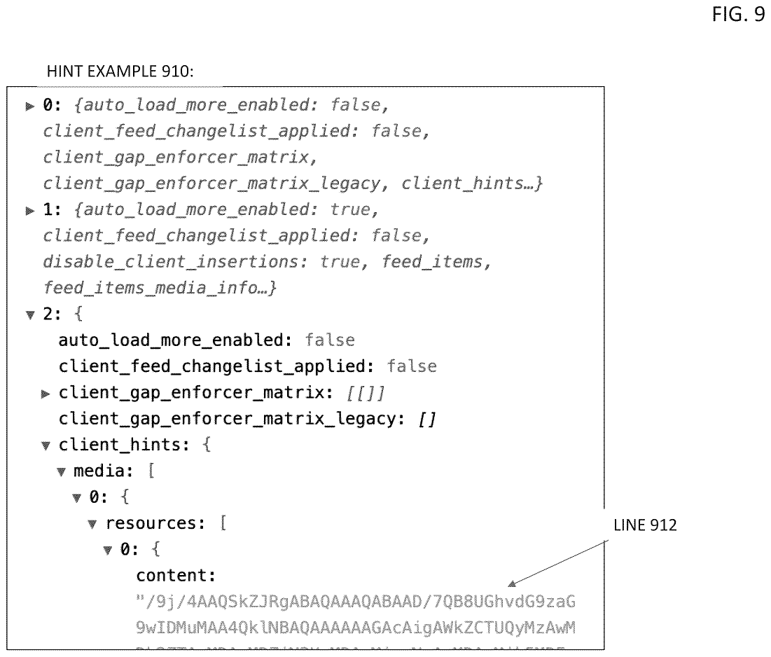

FIG. 9 depicts another example hint used in hint-based latency reduction in content display, in accordance with an illustrative embodiment. The example hint can be parsed by application 222 in FIG. 3. In particular, hint example 910 includes line 912, specifying image data.

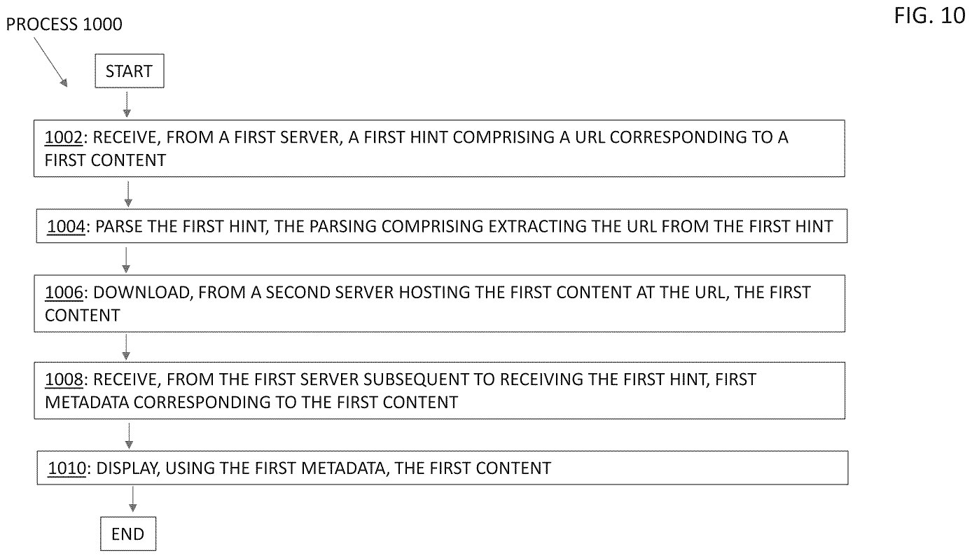

FIG. 10 depicts a flowchart of an example process for hint-based latency reduction in content display. in accordance with an illustrative embodiment. Process 1000 can be implemented in application 222 in FIG. 2.

At block 1002, the process receives, from a first server, a first hint comprising a URL corresponding to a first content. At block 1004, the process parses the first hint, the parsing comprising extracting the URL from the first hint. At block 1006, the process downloads, from a second server hosting the first content at the URL, the first content. At block 1008, the process receives, from the first server subsequent to receiving the first hint, first metadata corresponding to the first content. At block 1010, the process displays, using the first metadata, the first content. Then the process ends.

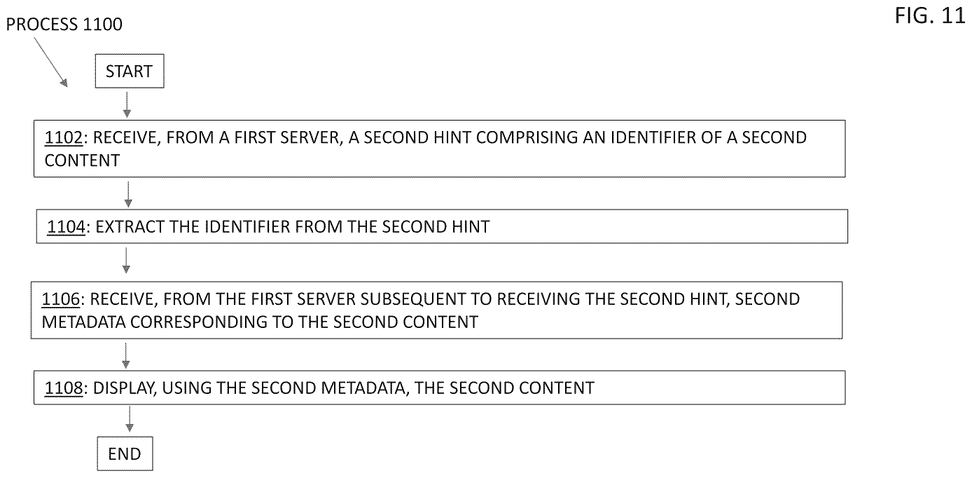

FIG. 11 depicts another flowchart of an example process for hint-based latency reduction in content display. in accordance with an illustrative embodiment. Process 1100 can be implemented in application 222 in FIG. 2.

At block 1102, the process receives, from a first server, a second hint comprising an identifier of a second content. At block 1104, the process extracts the identifier from the second hint. At block 1106, the process receives, from the first server subsequent to receiving the second hint, second metadata corresponding to the second content. At block 1108, the process displays, using the second metadata, the second content. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
receiving, from a first server, a first hint comprising a Uniform Resource Locator (URL) corresponding to a first content;
parsing the first hint, the parsing comprising extracting the URL from the first hint;
downloading, from a second server hosting the first content at the URL, the first content;
receiving, from the first server subsequent to receiving the first hint, first metadata corresponding to the first content; and
displaying, using the first metadata, the first content.

2. The computer-implemented method of claim 1, further comprising:
generating a media request to the first server; and
receiving, in response to the media request, the first hint.

3. The computer-implemented method of claim 1, wherein the first hint comprises a latency prediction associated with the downloading.

4. The computer-implemented method of claim 3, wherein an appearance of the first content is adjusted using the latency prediction.

5. The computer-implemented method of claim 1, wherein the first metadata comprises a first portion and a second portion, wherein the first hint comprises the first portion.

6. The computer-implemented method of claim 1, further comprising:
receiving, from the first server, a second hint comprising an identifier of a second content;
extracting the identifier from the second hint;
receiving, from the first server subsequent to receiving the second hint, second metadata corresponding to the second content; and
displaying, using the second metadata, the second content.

7. The computer-implemented method of claim 6, wherein the second content is present in a local cache.

8. The computer-implemented method of claim 6, wherein the second content is downloaded from the second server responsive to determining that the second content is absent from a local cache.

9. A non-transitory computer-readable medium storing a program, which when executed by a computer, configures the computer to:
receive, from a first server, a first hint comprising a Uniform Resource Locator (URL) corresponding to a first content;
parse the first hint, the parsing comprising extracting the URL from the first hint;
download, from a second server hosting the first content at the URL, the first content;
receive, from the first server subsequent to receiving the first hint, first metadata corresponding to the first content; and
display, using the first metadata, the first content.

10. The non-transitory computer-readable medium of claim 9, wherein the program, when executed by the computer, further configures the computer to:
generate a media request to the first server; and
receive, in response to the media request, the first hint.

11. The non-transitory computer-readable medium of claim 9, wherein the first hint comprises a latency prediction associated with the downloading.

12. The non-transitory computer-readable medium of claim 11, wherein an appearance of the first content is adjusted using the latency prediction.

13. The non-transitory computer-readable medium of claim 9, wherein the first metadata comprises a first portion and a second portion, wherein the first hint comprises the first portion.

14. The non-transitory computer-readable medium of claim 9, wherein the program, when executed by the computer, further configures the computer to:
receive, from the first server, a second hint comprising an identifier of a second content;
extract the identifier from the second hint;
receive, from the first server subsequent to receiving the second hint, second metadata corresponding to the second content; and
display, using the second metadata, the second content.

15. The non-transitory computer-readable medium of claim 14, wherein the second content is present in a local cache.

16. The non-transitory computer-readable medium of claim 14, wherein the second content is downloaded from the second server responsive to determining that the second content is absent from a local cache.

17. A system comprising:
a processor; and
a non-transitory computer readable medium storing a set of instructions, which when executed by the processor, configure the system to:
receive, from a first server, a first hint comprising a Uniform Resource Locator (URL) corresponding to a first content;
parse the first hint, the parsing comprising extracting the URL from the first hint;
download, from a second server hosting the first content at the URL, the first content;
receive, from the first server subsequent to receiving the first hint, first metadata corresponding to the first content; and
display, using the first metadata, the first content.

18. The system of claim 17, wherein the instructions, when executed by the processor, further configure the system to:
generate a media request to the first server; and
receive, in response to the media request, the first hint.

19. The system of claim 17, wherein the first hint comprises a latency prediction associated with the downloading.

20. The system of claim 19, wherein an appearance of the first content is adjusted using the latency prediction.
